(19) United States
(12) Patent Application Publication
(10) Pub. No.: US 2023/0356617 A1
(43) Pub. Date: Nov. 9, 2023

(54) METHODS AND APPARATUS FOR AUDITING AND TRACKING CLEAN ENERGY FLOW AMONGST DISTRIBUTED ENERGY RESOURCES

(71) Applicant: Enphase Energy, Inc., Petaluma, CA (US)

(72) Inventors: Raghuveer R. BELUR, Los Altos, CA (US); John Scott BERDNER, Grass Valley, CA (US)

(21) Appl. No.: 18/142,122

(22) Filed: May 2, 2023

Related U.S. Application Data
(60) Provisional application No. 63/337,859, filed on May 3, 2022.

(51) Int. Cl. B60L 53/66; B60L 53/68

(52) U.S. Cl. CPC B60L 53/665; B60L 53/68

(57) ABSTRACT

An electric vehicle supply equipment system for electric vehicle charging is provided and comprises an electric vehicle supply equipment that is connectable to a distributed energy resource for charging/discharging a battery of an electric vehicle and a controller in operative communication with at least one of a communication network, an electronic device of the electric vehicle, or a distributed energy resource controller for transmitting and receiving electric vehicle supply equipment information associated with a manufacturer of at least one of the electric vehicle supply equipment or the electric vehicle to provide charging/discharging of the battery at a private or public charging station associated with the manufacturer.

### CROSS-REFERENCE TO RELATED APPLICATIONS

The present application claims the benefit of and priority to U.S. Provisional Patent Application Ser. No. 63/337,859, filed on May 3, 2022, the entire contents of which is incorporated herein by reference.

### BACKGROUND

### Field of the Disclosure

Embodiments of the present disclosure relate generally to methods and apparatus configured for use with electric vehicles, and, for example, to methods and apparatus for auditing and tracking clean energy flow amongst distributed energy resources (DERs).

### Description of the Related Art

Electrical vehicles (EVs) are a mobile distributed energy resource, e.g., mobile storage. The EVs can be charged from a grid, from private energy sources (e.g., photovoltaics (PV) and energy storage systems (stationary)), or from a public energy source (e.g., electric vehicle supply equipment (EVSE)). A pure EV car may be thought of as a clean energy device, but that depends on a source of energy used to charge the EV. For example, if the EV is charged entirely from traditional fossil fuels, then the EV can, arguably be considered less clean, than, for example, an EV charged entirely from PV, wind, hydro, or other clean energy systems. Nonetheless, there is a growing desire and need for tracking of the source of energy in DERs such as an EV, and, in particular, to define the source of energy used by such a DER either as a percentage of overall energy consumption, a gross empiric, or otherwise.

Thus, the inventors provide an improved methods and apparatus for auditing and tracking clean energy flow amongst distributed energy resources (DERs).

### SUMMARY

Methods and apparatus configured for auditing and tracking clean energy flow amongst distributed energy resources (DERs) are provided herein. For example, in some embodiments, a method for auditing and tracking energy flow in a distributed energy resource comprises determining an amount of energy provided by a first energy source to the distributed energy resource, determining an amount of energy provided by a second energy source different from the first energy source to the distributed energy resource, determining a ratio between energy provided by the first energy source and energy provided by the second energy source, determining a net energy metering score based on the determined ratio, and one of increasing or decreasing energy provided by at least one of the first energy source or energy provided by the second energy source to the distributed energy resource.

In accordance with some aspects of the disclosure, a non-transitory computer readable storage medium has instructions stored thereon which when executed by a processor perform a method for auditing and tracking energy flow in a distributed energy resource. The method comprises a determining an amount of energy provided by a first energy source to the distributed energy resource, determining an amount of energy provided by a second energy source different from the first energy source to the distributed energy resource, determining a ratio between energy provided by the first energy source and energy provided by the second energy source, determining a net energy metering score based on the determined ratio, and one of increasing or decreasing energy provided by at least one of the first energy source or energy provided by the second energy source to the distributed energy resource.

In accordance with some aspects of the disclosure, an apparatus for auditing and tracking energy flow in a distributed energy resource comprises an electric vehicle supply equipment, a first energy source connected to the electric vehicle supply equipment, a second energy source connected to the electric vehicle supply equipment, and a controller coupled to the electric vehicle supply equipment, the first energy source, and the second energy source and configured to determine an amount of energy provided by the first energy source to the distributed energy resource, determine an amount of energy provided by the second energy source different from the first energy source to the distributed energy resource, determine a ratio between energy provided by the first energy source and energy provided by the second energy source, determine a net energy metering score based on the determined ratio, and one of increase or decrease energy provided by at least one of the first energy source or energy provided by the second energy source to the distributed energy resource.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with one or more embodiments of the present disclosure;

FIG. 2 is a diagram of an EVSE system that is configured to connect to the energy management system of FIG. 1, in accordance with one or more embodiments of the present disclosure;

FIG. 3 is a block diagram of an electronic device configured for use with the energy management system and the EVSE system of FIG. 1 and FIG. 2, respectively, in accordance with one or more embodiments of the present disclosure; and

FIG. 4 is a flowchart of a method for auditing and tracking energy flow in a distributed energy resource, in accordance with one or more embodiments of the present disclosure.

### DETAILED DESCRIPTION

Embodiments of the present disclosure generally relate to methods and apparatus for auditing and tracking clean energy flow amongst distributed energy resources (DERs). For example, a method for auditing and tracking energy flow in a distributed energy resource can comprise determining an amount of energy provided by a first energy source to the distributed energy resource. Next, the method can comprise determining an amount of energy provided by a second energy source different from the first energy source to the distributed energy resource. Next, the method can comprise determining a ratio between energy provided by the first energy source and energy provided by the second energy source. Next, the method can comprise determining a net energy metering score based on the determined ratio. In at least some embodiments, the method can comprise one of increasing or decreasing energy provided by at least one of the first energy source or energy provided by the second energy source to the distributed energy resource. The methods and apparatus described herein provide precise knowledge about charging habits and net energy metering (NEM) integrity of EV charging, thus promoting behavior, delivery of better products, and participation in one more grid service spaces.

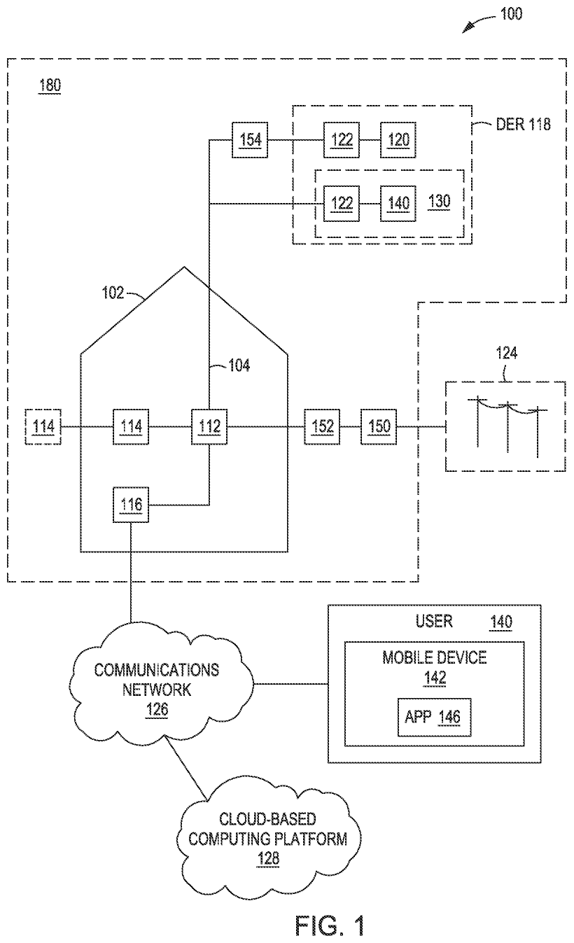

FIG. 1 is a block diagram of an energy management system (e.g., power conversion system, system 100) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home, commercial building, or separate mounting structure, having an associated DER 118 (distributed energy resource). The DER 118 is situated external to the structure 102. For example, the DER 118 may be located on the roof of the structure 102 or can be part of a solar farm. The structure 102 comprises one or more loads and/or energy storage devices 114 (e.g., appliances, electric hot water heaters, thermostats/detectors, boilers, electric vehicle supply equipment (EVSE), water pumps, and the like), which can be located within or outside the structure 102, and a DER controller 116, each coupled to a load center 112. Although the energy storage devices 114, the DER controller 116, and the load center 112 are depicted as being located within the structure 102, one or more of these may be located external to the structure 102.

The load center 112 is coupled to the DER 118 by an AC bus 104 and is further coupled, via a meter 152 and optionally a MID 150 (microgrid interconnect device), to a grid 124 (e.g., a commercial/utility power grid). The structure 102, the energy storage devices 114, DER controller 116, DER 118, load center 112, generation meter 154, the meter 152, and the MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a corresponding battery may be referred to as an AC battery.

Additionally, the inventors have found that an electric vehicle (EV) can be considered a mobile DER, which may be charged with either clean or dirty energy. For example, in at least some embodiments, methods and apparatus described herein can determine and assign an EV with a NEM score or metric that indicates a quantity of renewable energy stored in the EV. Thus, the inventive concepts described herein provide a methodology for measuring clean versus dirty energy used for charging the EV, maintaining an ongoing NEM score, and various ways of using and displaying that information, as described in greater detail below.

The power conditioners 122 invert the generated DC power from the plurality of RESs 120 and/or the battery 141 to AC power that is grid-compliant and couple the generated AC power to the grid 124 via the load center 112. The generated AC power may be additionally or alternatively coupled via the load center 112 to the one or more loads (e.g., EV, EVSE) and/or the energy storage devices 114. In addition, the power conditioners 122 that are coupled to the batteries 141 convert AC power from the AC bus 104 to DC power for charging the batteries 141. A generation meter 154 is coupled at the output of the power conditioners 122 that are coupled to the plurality of RESs 120 in order to measure generated power.

In at least some embodiments, the power conditioners 122 may be AC-AC converters that receive AC input and convert one type of AC power to another type of AC power. Alternatively, the power conditioners 122 may be DC-DC converters that convert one type of DC power to another type of DC power. The DC-DC converters may be coupled to a main DC-AC inverter for inverting the generated DC output to an AC output. Any AC to DC device which is configured to convert AC generated from renewable sources to DC can be used for charging an EV, e.g., a bidirectional inverter such as a simple charger onboard an EV. A key aspect of the present disclosure is the ability of measuring the energy (AC or DC) supplied to an EV battery.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method for auditing and tracking clean energy flow amongst DERs, e.g., an EVs, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the AC battery 130 itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage. The meter 152 measures power flows independently of MID state, i.e., when MID is closed and DER's are connected to the grid and when MID is open and DER's are isolated from the grid.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications (e.g., a grid connectivity control application (an application 146)) installed thereon for controlling the connectivity with the grid 124 as described herein. The may run on commercially available operating systems, such as IOS, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

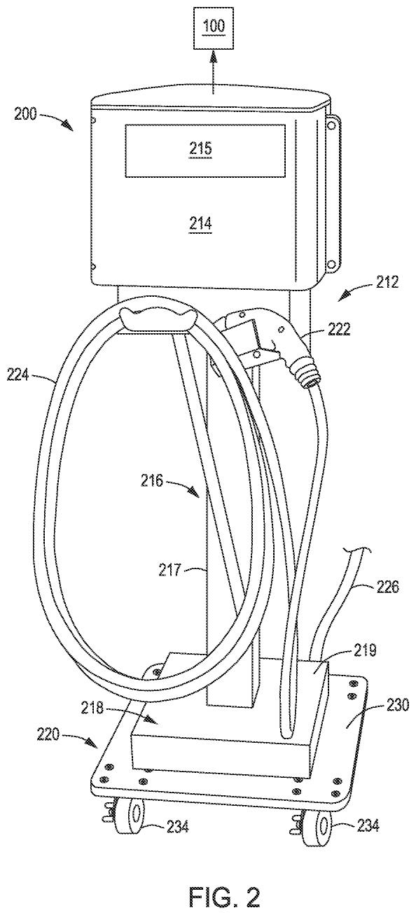

FIG. 2 is a diagram of an EVSE system (a system 200), in accordance with one or more embodiments of the present disclosure. As shown in FIG. 2, the system 200 is configured to connect to the system 100 and comprises electric vehicle supply equipment 212, a housing enclosure 214, a pedestal 216 having a base 218, and a transport module 220 coupled to the base 218. The electric vehicle supply equipment 212 can include an electric vehicle connector 222, which can comprise a cord 224, configured for connection to an electric vehicle inlet (not shown). The electric vehicle supply equipment 212 can include a service entrance cable 226 configured to connect, for example, to the load center 112 wiring to deliver energy to the electric vehicle connector 222. The electric vehicle supply equipment 212 can include a controller 215 (e.g., similar to the DER controller 116) which can be housed in the housing enclosure 214. The electric vehicle supply equipment 212 can also include ungrounded, grounded, and equipment grounding conductors, attachment plugs, and other fittings, devices, power outlets, or apparatuses necessary to deliver energy from the premises wiring (not shown) to an EV (not shown), all or a portion of which may be enclosed within housing enclosure 214. The pedestal 216 is coupled to and supports the housing enclosure 214 and may include a hollow tubular portion 217 and a base 218. The base 218 may include a base cover 219 and a base plate (not shown) configured to engage and be supported on a top surface of the transport module 220. The transport module 220 comprises a platform 230 that is configured to support the base 218, and wheels 234 are provided on the platform 230 to facilitate moving the system 200 when not connected to the system 100.

The electric vehicle supply equipment 212 (including electric vehicle connector 222, cord 224, and service entrance cable 226), the housing enclosure 214, and the pedestal 216 (including hollow tubular portion 217 and base 218), may be a commercially available electric vehicle charge station such as, for example but not limited to, a CS Series Public EVSE provided by ClipperCreek, Inc. of Auburn, Calif.

As described above, inventive concepts described herein can treat an EV as a mobile DER that may be charged with either clean or dirty energy. Clean energy may considered to be photovoltaic (PV), wind, or hydro, for example. Conversely, dirty energy may be considered at least one of coal, gas, or oil, for example. Each of the clean and dirty sources may be used to charge an EV, and in many instances of charging the system 200 may know whether the source of energy is clean or dirty. For example, in at least some embodiments, when a homeowner sets the system 200 to charge an EV only from PV (e.g., one or more of the RESs 120), or only from storage in a system that charges storage only from PV (e.g., the energy storage devices 114), an EV's NEM score may be updated with an amount of energy charged, all of which is clean. Conversely, in at least some embodiments, when the system 200 is charging in a home that lacks any clean energy resources, an EV would be charged entirely from a grid (e.g., grid 124). Thus, in such embodiments, an entirety of energy used to charge the EV may be designated dirty, or a particular ratio may be attributed to the grid energy at that time, and the NEM score can be updated accordingly, e.g., using a ratio of clean energy to total energy delivered to the EV.

The inventors have found that grid energy is not necessarily a straight-forward categorization of dirty energy, but rather a percentage of the grid energy may come from clean energy sources such as utility-scale PV, hydro, and wind generation systems. For example, there may be calculable information indicating that energy delivered in a particular location between the hours of 4 pm and 6 pm is 20% PV, whereas energy delivered between 4 am and 6 am is 0% PV. For an EV owner that charges 20 kWh, the difference in grid energy may result in a different accumulation of clean versus dirty energy, that is, 4 kWh clean between 4 pm and 6 pm and 0 kWh clean between 4 am and 6 am. In at least some embodiments, the calculation and the information resulting from the calculation can be used to promote charging habits dependent on grid energy, impact of charging on the grid, locally-sourced energy, and one or more other factors. Likewise, energy delivered from a home may not always be entirely clean or entirely dirty. For example, in a time when all clean energy sources (e.g., PV and storage in a system) are less than an overall load, including EV, then the grid is contributing a percentage of total consumption. Thus, in at least some embodiments, a calculation can be done using a ratio of clean energy to dirty energy and applying that ratio to the total energy delivered to the EV.

Other variants of calculating the ratio of clean energy to dirty energy can also be used. For example, in at least some embodiments, an average ratio over the time of charging, segmented averages can also be used in calculating a ratio of clean energy to dirty energy.

Using the EV's NEM score can facilitate optimizing using only clean energy to charge an EV. For example, based on the NEM score, a user can configure the system 200 to charge EVs directly and solely from the clean energy sources, and thus allowing a user to shift a higher percentage of dirty energy, for example, to the home loads.

In at least some embodiments, the EV NEM score may be expressed as a percentage of overall energy charged, may be a gross number indicating total clean energy charged, or any number of other mathematical representations. In at least some embodiments, the EV NEM score may also distinguish between a type of clean energy and dirty energy sources—distinguishing between PV, wind, hydro, coal, gas, oil, etc. Additionally, in at least some embodiments, a historical charging habit of an EV may be maintained (e.g., in the system 200 and/or in a memory of the DER controller 116), showing on a graphical historical basis how the NEM score has changed based on EV owner behavior, charging habits, or other. Such information can be useful in understanding an effect of product features, siting or pricing local public EVSEs, influencing legislation to promote certain products, tariffs, or other energy-related initiatives, or any number of other purposes. The information can also be used in combination with promotional programs that encourage (behavioral encouragement information) EV owners to charge at certain locations during certain times when energy is cleaner and both location and time may be dynamically adjusted in real-time based on one or more factors. In at least some embodiments, the behavioral encouragement information can also be used as a form of demand response that participates in grid services programs, e.g., for promoting clean energy charging behavior, as opposed to promoting lower usage or delivery, which are, typically, used in traditional grid services. For example, in at least some embodiments, if there is a period of time or particular location that is known to be more desirable because clean energy is available, which would otherwise be lost, an EV owner may be compensated or otherwise encouraged to charge during that time or at that location. Similarly, baseline behavior may be achieved and/or influenced using the behavioral encouragement information. For example, an EV owner may also be incentivized (or compensated) to charge from a home during a particular event with the knowledge that the energy comes directly from a PV system, thus reducing the impact of delivering that PV energy to the grid and then re-delivering it to the EV owner at a later time.

The inventive methods described herein may be integrated in and/or configured to interact with a home management system (e.g., the system 100 and/or the system 200) and may use criteria including, but not limited to, overall home load, energy generation, forecasted load, weather patterns, storage state-of-charge (SOC), time-of-use rates, windows, etc.

While the inventive concepts have been described herein with respect to an NEM score for an EV, the inventive concepts are not so limited. For example, in at least some embodiments, an NEM score may be applied to stationary or other mobile DERs that allow time-dependent charging and discharging, e.g., home batteries, PCs, smartphones, and other rechargeable mobile devices, such as lawn equipment, camping equipment, etc.

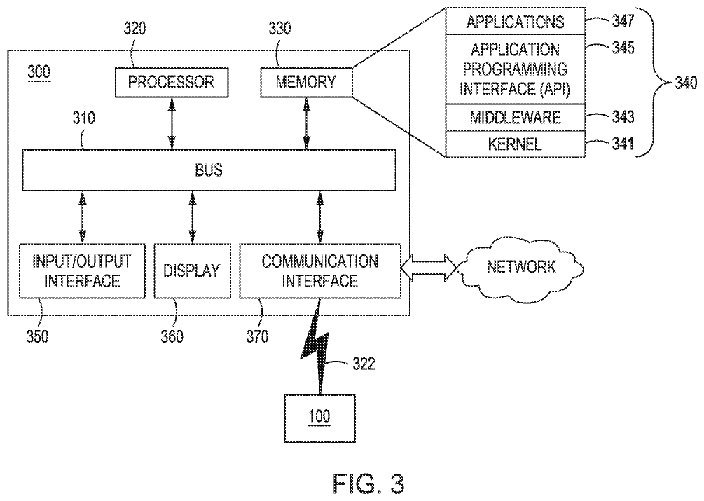

FIG. 3 is a block diagram of an electronic device configured for use with the energy management system and the EVSE system of FIG. 1 and FIG. 2, respectively, in accordance with one or more embodiments of the present disclosure. One or more of the components of electronic device 300 may also be a component of the devices of the system 100 (e.g., the storage system 108, the smart switch 110, the DER controller 116, the combiner 107, the one or more PVs 106 (e.g., solar panels), and the load center 112), a component of an EV, and a component of the system 200 (e.g., the controller 215).

The electronic device 300 includes a bus 310, a processor 320 (or controller), a memory 330 (or storage, e.g., non-transitory computer readable storage medium), an input/output interface 350, a display 360, and a communication interface 370. At least one of the above-described components may be omitted from the electronic device 300 or another component may be further included in the electronic device 300.

The bus 310 may be a circuit connecting the above-described components (e.g., the processor 320), the memory 330, the input/output interface 350, the display 360, and the communication interface 370 and transmitting communications (e.g., control messages and/or data) between the above-described components.

The processor 320 may include one or more of a central processing unit (CPU), an application processor (AP), and a communication processor (CP). The processor 320 can control at least one of the other components of the electronic device 300 and/or processing data or operations related to communication.

The memory 330 may include volatile memory and/or non-volatile memory. The memory 330 can store data or commands/instructions related to at least one of the other components of the electronic device 300. The memory 330 can store software and/or a program module 340 (e.g., instructions for performing one or more of the operations/functions of the system 100, the system 200, and/or the EV described herein). For example, the program module 340 may include a kernel 341, middleware 343, an API 345, application 347 (e.g., software-based application for performing one or more of the operations/functions of the system 100, the system 200, and/or the EV described herein). The kernel 341, the middleware 343 or at least part of the API 345 may be called an operating system.

The kernel 341 can control or managing system resources (e.g., the bus 310, the processor 320, the memory 330, etc.) used to execute operations or functions of other programs (e.g., the middleware 343, the API 345, and the applications 347). The kernel 341 provides an interface capable of allowing the middleware 343, the API 345, and the applications 347 to access and control/manage the individual components of the electronic device 300.

The middleware 343 may be an interface between the API 345 or the applications 347 and the kernel 341 so that the API 345 or the applications 347 can communicate with the kernel 341 and exchange data therewith. The middleware 343 is capable of processing one or more task requests received from the applications 347. The middleware 343 can assign a priority for use of system resources of the electronic device 300 (e.g., the bus 310, the processor 320, the memory 330, etc.) to the application 347. The middleware 343 processes one or more task requests according to a priority assigned to at least one application program, thereby performing scheduling or load balancing for the task requests.

The API 345 may be an interface that is configured to allow the applications 347 to control functions provided by the kernel 341 or the middleware 343. The API 345 may include at least one interface or function (e.g., instructions) for file control, window control, image process, text control, or the like. For example, during the methods described herein, the API 345 allows the applications 347 to display one or more user interfaces that allow a user to navigate, for example, through one or more screens to enter information associated with the methods.

The input/output interface 350 is capable of transferring instructions or data received from a user or external devices to one or more components of an electronic device (e.g., one or more of the components of the system 100). The input/output interface 350 is capable of outputting instructions or data, received from one or more components of the electronic device 300, to the user or external devices. The input/output interface 350 can be configured to create one or more GUIs for receiving a user input or an input from an electronic device (e.g., a user smart phone). In at least some embodiments, the input can be a request for enabling one or more of the above-described functions.

The display 360 may include a liquid crystal display (LCD), a flexible display, a transparent display, a light emitting diode (LED) display, an organic LED (OLED) display, micro-electro-mechanical systems (MEMS) display, an electronic paper display, etc. The display 360 can display various types of content (e.g., texts, images, videos, icons, symbols, etc.). The display 360 may also be implemented with a touch screen. The display 360 can receive touches, gestures, proximity inputs or hovering inputs, via a stylus pen, or a user's body. Accordingly, the display 350 can be used to receive a user input on one or more GUIs.

The communication interface 370 can establish communication between the electronic device 300 and an external device (e.g., mobile device 142, the DER controller 116, etc. of the system 100, the controller 215, and/or the controller of the EV) connected to a network via wired or wireless communication.

Wireless communication may employ, as cellular communication protocol, at least one of long-term evolution (LTE), LTE advance (LTE-A), code division multiple access (CDMA), wideband CDMA (WCDMA), universal mobile telecommunications system (UMTS), wireless broadband (WiBro), and global system for mobile communication (GSM). Wireless communication may also include short-wireless communication 322. Short-wireless communication 322 may include at least one of wireless fidelity (Wi-Fi), BT, BLE, Zigbee, near field communication (NFC), magnetic secure transmission (MST), etc. Wired communication may include at least one of universal serial bus (USB), high definition multimedia interface (HDMI), recommended standard, and plain old telephone service (POTS). The network may include at least one of a telecommunications network, e.g., a computer network (e.g., local area network (LAN) or WAN), the Internet, and a telephone network.

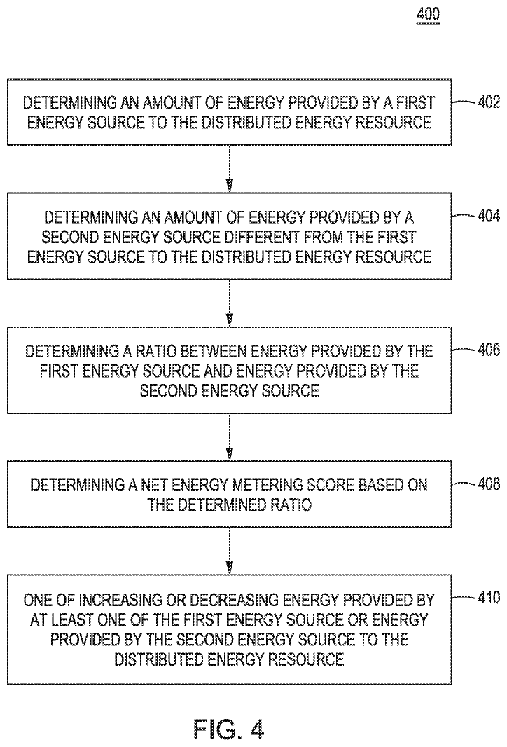

FIG. 4 is a flowchart of a method 400 for auditing and tracking energy flow in a distributed energy resource, in accordance with one or more embodiments of the present disclosure. The method 400 is described for use with a distributed energy resource that is an EV.

For example, at 402, the method 400 comprises determining an amount of energy provided by a first energy source to the distributed energy resource. For example, one or more of the controllers described above can be used to determine 402. In at least some embodiments, the DER controller 116 of the system 100 and/or the controller 215 of the system 200 can be used to determine the amount of energy provided by the first energy source to the distributed energy resource (e.g., an EV). For example, the first energy source can be at least one of photovoltaic, wind, or hydro. In at least some embodiments, the first energy source can be the one or more of the RESs 120 (e.g., a PV).

Next, at 404, the method 400 comprises determining an amount of energy provided by a second energy source different from the first energy source to the distributed energy resource. For example, one or more of the controllers described above can be used to determine 404. In at least some embodiments, the DER controller 116 of the system 100 and/or the controller 215 of the system 200 can be used to determine the amount of energy provided by the second energy source to the EV. For example, the second energy source can be the grid 124 that can use energy created by using at least one of electricity, coal, gas, or oil.

Next, at 406, the method 400 comprises determining a ratio between energy provided by the first energy source and energy provided by the second energy source. For example, the DER controller 116 and/or the controller 215 can use a ratio between clean energy delivered to the EV and dirty energy delivered to the EV. In at least some embodiments, each of the clean and dirty sources may be used to charge an EV, and the controller 215 of the system 200 knows whether the source of energy is clean or dirty.

Next, at 408, the method 400 comprises determining a net energy metering score based on the determined ratio. For example, the NEM score may be expressed as a percentage of overall energy charged, may be a gross number indicating total clean energy charged, or any number of other mathematical representations. In at least some embodiments, based on the NEM score, a user can configure the system 200 to charge EVs directly and solely from the clean energy sources, and thus allowing a user to shift a higher percentage of dirty energy, for example, to the home loads. In at least some embodiments, after determining the net energy metering score based on the determined ratio, the method 400 may comprise providing the net energy metering score to a user. In at least some embodiments, the net energy metering score can be provided to a user via the display 360.

Next, at 410, the method 400 comprises one of increasing or decreasing energy provided by at least one of the first energy source or energy provided by the second energy source to the distributed energy resource. For example, the controller 215 can be configured to automatically increase or decrease energy provided by RESs 120 and/or energy provided by the grid 124.

In at least some embodiments, the method 400 can comprise determining a time when the energy provided by the first energy source is at a maximum and when the energy provided by the second energy source is at a minimum. For example, calculable information indicating that energy delivered in a particular location between the hours of 4 pm and 6 pm is 20% PV, whereas energy delivered between 4 am and 6 am is 0% PV. For an EV owner that charges 20 kWh, the difference in grid energy may result in a different accumulation of clean versus dirty energy, that is, 4 kWh clean between 4 pm and 6 pm and 0 kWh clean between 4 am and 6 am.

In at least some embodiments, the method 400 comprises determining and storing at least one of a location where a user charges the distributed energy resource or a time when the user charges the distributed energy resource. For example, the DER controller 116 may transmit a time when the EV is charged using the RES 120, or the DER controller 116 and/or the controller 215 may receive location and or time information from a remote electronic device when the EV is charged using, for example, a public charging station. Additionally, the method 400 may comprise displaying (e.g., via the display 360) changes in the net energy metering score based on at least one of the location where the user charges the distributed energy resource or the time when the user charges the distributed energy resource.

In at least some embodiments, methods described herein can be used to track clean energy discharged from the EV. In such embodiments, a meter (e.g., such as the meters described herein) can be configured to monitor how much energy flows from the EV to the grid and decrement a net amount of clean energy removed from the EV and transmitted to the grid, i.e., bi-directionality for tracking net green energy. Additionally, the controller can be configured to transmit control signals to the EV to discontinue exporting to the grid when an energy score (e.g., a net green energy score) reaches zero.

While the foregoing is directed to embodiments of the present disclosure, other and further embodiments of the disclosure may be devised without departing from the basic scope thereof, and the scope thereof is determined by the claims that follow.

What is claimed is:

1. A method for auditing and tracking energy flow in a distributed energy resource, comprising:
determining an amount of energy provided by a first energy source to the distributed energy resource;
determining an amount of energy provided by a second energy source different from the first energy source to the distributed energy resource;
determining a ratio between energy provided by the first energy source and energy provided by the second energy source;
determining a net energy metering score based on the determined ratio; and
one of increasing or decreasing energy provided by at least one of the first energy source or energy provided by the second energy source to the distributed energy resource.

2. The method of claim 1, further comprising, after determining the net energy metering score based on the determined ratio, providing the net energy metering score to a user.

3. The method of claim 1, further comprising one of automatically increasing or decreasing energy provided by at least one of the first energy source or energy provided by the second energy source to the distributed energy resource comprises.

4. The method of claim 1, wherein the distributed energy resource is an electric vehicle.

5. The method of claim 1, wherein the first energy source is at least one of photovoltaic, wind, or hydro.

6. The method of claim 1, wherein the second energy source is at least one of coal, gas, or oil.

7. The method of claim 1, further comprising determining and storing at least one of a location where a user charges the distributed energy resource or a time when the user charges the distributed energy resource.

8. The method of claim 7, further comprising displaying changes in the net energy metering score based on at least one of the location where the user charges the distributed energy resource or the time when the user charges the distributed energy resource.

9. The method of claim 1, further comprising determining a time when the energy provided by the first energy source is at a maximum and when the energy provided by the second energy source is at a minimum.

10. A non-transitory computer readable storage medium having instructions stored thereon which when executed by a processor perform a method for auditing and tracking energy flow in a distributed energy resource, comprising:
determining an amount of energy provided by a first energy source to the distributed energy resource;
determining an amount of energy provided by a second energy source different from the first energy source to the distributed energy resource;
determining a ratio between energy provided by the first energy source and energy provided by the second energy source;
determining a net energy metering score based on the determined ratio; and
one of increasing or decreasing energy provided by at least one of the first energy source or energy provided by the second energy source to the distributed energy resource.

11. The non-transitory computer readable storage medium of claim 10, wherein the method further comprises, after determining the net energy metering score based on the determined ratio, providing the net energy metering score to a user.

12. The non-transitory computer readable storage medium of claim 10, wherein the method further comprises one of automatically increasing or decreasing energy provided by at least one of the first energy source or energy provided by the second energy source to the distributed energy resource comprises.

13. The non-transitory computer readable storage medium of claim 10, wherein the distributed energy resource is an electric vehicle.

14. The non-transitory computer readable storage medium of claim 10, wherein the first energy source is at least one of photovoltaic, wind, or hydro.

15. The non-transitory computer readable storage medium of claim 10, wherein the second energy source is at least one of coal, gas, or oil.

16. The non-transitory computer readable storage medium of claim 10, wherein the method further comprises determining and storing at least one of a location where a user charges the distributed energy resource or a time when the user charges the distributed energy resource.

17. The non-transitory computer readable storage medium of claim 16, wherein the method further comprises displaying changes in the net energy metering score based on at least one of the location where the user charges the distributed energy resource or the time when the user charges the distributed energy resource.

18. The non-transitory computer readable storage medium of claim 10, wherein the method further comprises determining a time when the energy provided by the first energy source is at a maximum and when the energy provided by the second energy source is at a minimum.

19. An apparatus for auditing and tracking energy flow in a distributed energy resource, comprising:
an electric vehicle supply equipment;
a first energy source connected to the electric vehicle supply equipment;
a second energy source connected to the electric vehicle supply equipment; and
a controller coupled to the electric vehicle supply equipment, the first energy source, and the second energy source and configured to:
determine an amount of energy provided by the first energy source to the distributed energy resource;
determine an amount of energy provided by the second energy source different from the first energy source to the distributed energy resource;
determine a ratio between energy provided by the first energy source and energy provided by the second energy source;
determine a net energy metering score based on the determined ratio; and
one of increase or decrease energy provided by at least one of the first energy source or energy provided by the second energy source to the distributed energy resource.

20. The apparatus of claim 19, wherein the controller is further configured to, after determining the net energy metering score based on the determined ratio, provide the net energy metering score to a user.
